(19) United States
(12) Patent Application Publication
(10) Pub. No.: US 2025/0020411 A1
(43) Pub. Date: Jan. 16, 2025

(54) TAILORED VARYING GEOMETRY HEAT EXCHANGERS ENABLED BY ADDITIVE MANUFACTURING TO ADDRESS AND EXPLOIT CHANGING HEAT TRANSFER PHENOMENA DURING PHASE CHANGE

(71) Applicant: Georgia Tech Research Corporation, Atlanta, GA (US)

(72) Inventors: Srinivas Garimella, Atlanta, GA (US); Ryan Giometti, Atlanta, GA (US); Matthew Hughes, Atlanta, GA (US)

(21) Appl. No.: 18/772,357

(22) Filed: Jul. 15, 2024

Related U.S. Application Data
(60) Provisional application No. 63/526,748, filed on Jul. 14, 2023.

(51) Int. Cl. F28D 7/16; B33Y 80/00

(52) U.S. Cl. CPC F28D 7/1623; B33Y 80/00

(57) ABSTRACT

An exemplary embodiment of the present disclosure provides a heat exchanger comprising a chamber and a channel system located within the chamber. The channel system can comprise a repeating set of a first end, a second end, and a plurality of channels between the first end and the second end. A physical property of the plurality of channels can vary from the first end to the second end. A plurality of distribution manifolds can redirect at least a portion of the liquid phase of the first fluid to a plurality of bypass channels. The first fluid can flow through the plurality of channels, and the second fluid can flow through the chamber external to the plurality of channels, which can result in a transfer of heat.

### CROSS-REFERENCE TO RELATED APPLICATIONS

This application claims the benefit of U.S. Provisional Application Ser. No. 63/526,748, filed on 14 Jul. 2024, which is incorporated herein by reference in its entirety as if fully set forth below.

### FIELD OF THE DISCLOSURE

The various embodiments of the present disclosure relate generally to heat exchangers.

### BACKGROUND

Cooling of high-power electronics via refrigerant evaporation presents a significant opportunity to reduce the size, weight, and power (SWaP) consumed by thermal management systems. Recent advances have led to demonstration of compact microchannel evaporators with heat transfer coefficients in excess of 100 kW/m²K and low pumping powers. Condensers are often the largest component in a two-phase cooling system. Commercial condensers are typically shell-and-tube designs with heat transfer coefficients less than 5000 W/m²K. Military systems often use a secondary coolant loop to transport heat from condensers. For example, naval platforms use a freshwater cooling system, while air platforms have a polyalphaolefin (PAO) coolant loop. Recent progress in metal additive manufacturing has enabled the fabrication of air heat sinks and cold plates with complex flow geometries. Additive manufacturing can also allow for thinner walls, reducing weight and thermal resistance. Most metal additive manufacturing technologies are based on powder processing, with a limited number of alloys commercially available. Process parameters can greatly affect the microstructure and mechanical properties of the resulting metallic heat exchanger, leading to concerns about long-term durability. Heat transfer enhancement using internal structures embedded inside flow passages is commonly used to increase local convection heat transfer, but such structures have been limited to simple geometries fabricated using conventional manufacturing techniques. Additive manufacturing can enable more complex structures, but demonstrations to date have been largely limited to intuitive designs. Topology optimization has recently been applied to the design of additively manufactured cold plates, but the designs are limited to two-dimensional optimization due to computational complexity. New tools are needed to enable the full potential of additive manufacturing to realize optimal three-dimensional designs. What is needed are innovative phase-change heat exchangers such as evaporators and condensers enabled by metal additive manufacturing for efficient cooling of electronics. The present disclosure provides such systems.

### BRIEF SUMMARY

An exemplary embodiment of the present disclosure provides a heat exchanger comprising a chamber and a channel system located within the chamber. The channel system can comprise a first end, a second end, and a plurality of channels between the first end and the second end. A physical property of the plurality of channels can vary from the first end to the second end. The heat exchanger can be configured to allow a first fluid to flow through the plurality of channels from the first end to the second end and a second fluid to flow through the chamber external to the plurality of channels, resulting a transfer of heat between the first and second fluids. This repeating pattern of plurality of channels with first and second ends of incrementally or continuously varying geometries comprises the overall tailored phase-change heat exchanger such as a condenser or evaporator with high heat transfer capacity in a compact envelope previously not possible.

In any of the embodiments disclosed herein, the physical property of the plurality of channels can comprise a quantity of channels.

In any of the embodiments disclosed herein, the physical property of the plurality of channels can comprise an internal channel diameter of the plurality of channels.

In any of the embodiments disclosed herein, the physical property of the plurality of channels can comprise an internal geometry of the plurality of channels.

In any of the embodiments disclosed herein, the plurality of channels can comprise a first channel section comprising one or more first channels having a first set of physical properties one or more second channels having a second set of physical properties, and a distribution manifold positioned between the one or more first channels and the one or more second channels. The one or more first channels, the one or more second channels, and the distribution manifold can be in fluid communication with each other.

In any of the embodiments disclosed herein, a quantity of the one or more first channels can be less or more than a quantity of the one or more second channels.

In any of the embodiments disclosed herein, an internal channel diameter of the one or more first channels can be greater or smaller than an internal channel diameter of the one or more second channels.

In any of the embodiments disclosed herein, the heat exchanger can be configured to provide a near-constant or optimally varying mass flux of the first fluid through the first channel section, with portions of the liquid or vapor phase of the total flow being bypassed in dedicated liquid or vapor management/bypass channels.

In any of the embodiments disclosed herein, the first fluid can be a two-phase fluid.

In any of the embodiments disclosed herein, at least a portion of the heat exchanger can be manufactured by an additive manufacturing process.

An exemplary embodiment of the present disclosure provides a heat exchanger system comprising a chamber and a plurality of channels. The chamber can define an interior volume, and the interior volume can be configured to receive a second fluid at a second fluid inlet and expel the second fluid at a second fluid outlet. The plurality of channels can extend through at least a portion of the interior volume, and can be configured to receive a first fluid at a first fluid inlet and expel the first fluid at the first fluid outlet. The plurality of channels can comprise a first channel having a first physical property and a second channel having a second physical property different than the first physical property.

In some embodiments, a physical of property of the first channel and/or second channel can continuously change along a length of the respective channel.

In any of the embodiments disclosed herein, the first and second channels can be in fluid communication.

In any of the embodiments disclosed herein, the first channel can be part of one or more first channels, each of the one or more first channels having a first physical property. The second channel can be part of one or more second channels, each of the one or more second channels having the second physical property.

In any of the embodiments disclosed herein, a number of first channels in the one or more first channels can be different than a number of second channels in the one or more second channels.

In any of the embodiments disclosed herein, the first physical property can be selected from a group consisting of: channel length, internal channel diameter, channel wall thickness, channel cross-sectional shape, tapering profile, channel surface (internal or external) features (including ribs, fins, surface roughness, and the like), quantity of channels, and channel spacing, and the second physical property can be selected from a group consisting of: channel length, internal channel diameter, channel wall thickness, channel cross-sectional shape, tapering profile, channel surface (internal or external) features (including ribs, fins, surface roughness, and the like), quantity of channels, and channel spacing. In some embodiments two or more, three or more, four or more, five or more, or six or more of these physical properties can change along the length of one or more channels or channel sections.

In any of the embodiments disclosed herein, the heat exchanger system can further comprise a distribution manifold. The distribution manifold can be configured to receive the first fluid from the first channel, the first fluid comprising a liquid phase and a vapor phase.

The distribution manifold can be further configured to pass at least a portion of the vapor phase of the first fluid to the second channel.

In any of the embodiments disclosed herein, the heat exchanger system can further comprise a bypass channel. The bypass channel can be configured to receive at least a portion of the liquid phase of the first fluid from the distribution manifold and pass the at least a portion of the liquid phase of the first fluid to the first fluid outlet.

In any of the embodiments disclosed herein, the first fluid inlet can be in fluid communication with a first fluid source. The first fluid source can comprise the first fluid substantially in a vapor phase.

An exemplary embodiment of the present disclosure provides a method of making a heat exchanger. The method can comprise manufacturing the heat exchanger system. At least a portion of the heat exchanger system can be manufactured via an additive manufacturing process.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a diagram of a heat exchanger, in accordance with an exemplary embodiment of the present disclosure.

FIG. 2 provides a diagram of the progression of physical properties of a heat exchanger, in accordance with an exemplary embodiment of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

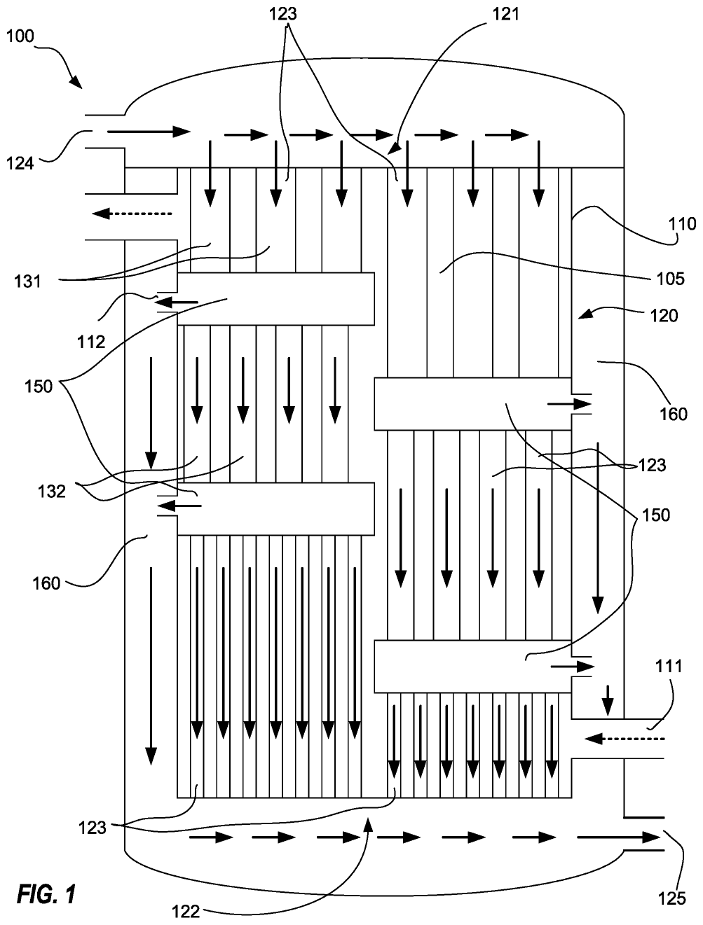

As shown in FIG. 1, an exemplary embodiment of the present disclosure provides a heat exchanger 100. In some embodiments, at least a portion of the heat exchanger can be additively manufactured. Vapor-liquid phase change can be achieved during flows through a bank of tubes, and heat transfer with a coupling fluid flowing around the tubes. The changing number of tubes and varying topological features coupled with liquid (and/or vapor) management can enable significant size reduction compared to conventional phase-change heat exchangers that typically have straight, smooth, or extruded tubes with fins or similar patterns invariant along the length of the heat exchanger. These novel features can yield size reduction by maintaining velocities and thin liquid films in the tubes needed for optimal heat transfer and pressure drop by continuously varying the number of tubes, varying the topological features as heat exchange proceeds, and managing liquid or vapor inventory with dedicated channels. In some embodiments, tube layout and liquid management channels can be configured and modified periodically using “hollow” baffle regions (also referred to as distribution manifolds), where the liquid-vapor mixture redistributes into succeeding banks of tubes (i.e., channels) with different optimized surface area.

For example, as shown in FIG. 1, the heat exchanger 100 can comprise a chamber 110 and a channel system 120. In some embodiments, the chamber 110 can define an interior volume 105 and can be configured to receive a second fluid at a second fluid inlet 111 and expel the second fluid at a second fluid outlet 112. The channel system 120, in some embodiments, can be located within the chamber 110, comprising a first end 121, a second end 122, and a plurality of channels 123 between the first end 121 and the second end 122. The plurality of channels 123, in some embodiments, can extend through at least a portion of the interior volume 105 of the chamber 110, and can be configured to receive a first fluid at a first fluid inlet 124 and expel a first fluid at a first fluid outlet 125.

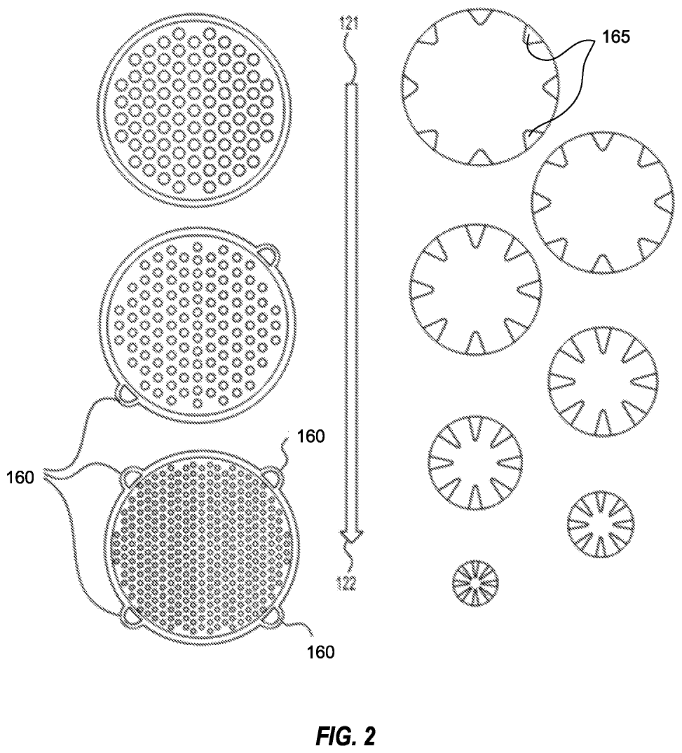

In some embodiments, a physical property of the plurality of channels 123 can vary from the first end 121 to the second end 122. In an example embodiment, the physical property of the plurality of channels 123 can comprise a quantity of channels. In an example embodiment, the physical property of the plurality of channels 123 can comprise an internal channel diameter of the plurality of channels 123. In an example embodiment, the physical property of the plurality of channels 123 can comprise an internal geometry of the plurality of channels 123. The plurality of channels, in some embodiments, can vary in a plurality of physical properties from the first end 121 to the second end 122. The plurality of physical properties can include any combination of but is not limited to channel length, internal channel diameter, channel wall thickness, channel cross-sectional shape, tapering profile channel surface (internal or external) features (including protrusions, ribs, fins, patterned surface roughness, and the like, as shown in FIG. 2), quantity of channels, and channel spacing. For example, in some embodiments, each channel section can have a different number of channel with different spacing and different channel diameter, internal rib/fin patterns, etc. than a second section (or third, fourth, or fifth channel section). Channel length, in some embodiments, can be defined as the length of a channel along a direction of internal flow. In an example embodiment, a channel of the plurality of channels 123 can be cylindrical, and the internal channel diameter can be defined as the internal diameter of the circular cross-section of the channel of the plurality of channels. The channel wall thickness, in some embodiments, can be defined as the distance, uniform or not, between an internal surface and an external surface of a channel of a plurality of channels 123. Channel cross-sectional shape, in some embodiments, can be defined as the shape of a cross-section of the channel of the plurality of channels 123 perpendicular to the direction of internal flow. Tapering profile, in some embodiments, can be determined as a function based at least in part on the channel length, and can define an external channel diameter and/or internal channel diameter at any point along the channel length of a channel 123 of the plurality of channels 123. The external channel diameter, in some embodiments, is based at least in part on the wall thickness and the internal channel diameter. In an exemplary embodiment, the tapering profile can be such that the external channel diameter and/or internal channel diameter decreases or increases from the first end to the second end.

In some embodiments, the plurality of channels 123 can comprise a first channel section comprising one or more first channels 131 having a first set of physical properties, one or more second channels 132 having a second set of physical properties, and a distribution manifold 150 positioned between the one or more first channels 131 and the one or more second channels 132, wherein the one or more first channels 131, the one or more second channels 132 and the distribution manifold 150 can be in fluid communication with each other. The first channel section, in some embodiments, can be part of a plurality of channel sections, wherein the plurality of channel sections can be in fluid communication with one another and/or in parallel, wherein the plurality of channel sections can each have a respective first and second set of physical properties which can vary from the first and second set of physical properties of other channel sections of the plurality of channel sections. In some embodiments, a quantity of the one or more first channels 131 can be less or more than a quantity of the one or more second channels 132. In some embodiments, the internal channel diameter of the one or more first channels 131 can be greater or smaller than the internal channel diameter of the one or more second channels 132. The first set of physical properties and the second set of physical properties, in some embodiments, can include but are not limited to: channel length, internal channel diameter, channel wall thickness, channel cross-sectional shape, tapering profile, surface features, the like, and combinations thereof. The heat exchanger 100 can be configured, in some embodiments, to provide a near-constant or optimally varying mass flux of the first fluid through the first channel section, with portions of the liquid or vapor phase of the total flow being bypassed in dedicated liquid or vapor management channels.

As shown in FIG. 1, the plurality of channels 123 can comprise a first channel 131 and a second channel 132. In some embodiments, the first channel 131 and the second channel 132 can be in fluid communication. In some embodiments, the first channel 131 can have a first physical property, and the second channel 132 can have a second physical property different than the first physical property. In some embodiments, the first channel 131 can be part of one or more first channels 131, each of the one or more first channels 131 having the first physical property, and wherein the second channel 132 can be part of one or more second channels 132, each of the one or more second channels 132 having the second physical property. In some embodiments, the number of first channels 131 in the one or more first channels 131 can be different than a number of second channels 132 in the one or more second channels 132.

The heat exchanger 100, in some embodiments, further comprises the distribution manifold 150, which can be configured to receive the first fluid from the first channel 131 (or plurality of first channels 131), the first fluid comprising a liquid phase and a vapor phase. The distribution manifold 150 can be configured to pass at least a portion of the vapor phase of the first fluid to the second channel 132 (or plurality of second channels 132). The heat exchanger 100, in some embodiments, can further comprise a bypass channel 160, wherein the bypass channel 160 can be configured to receive at least a portion of the liquid phase of the first fluid from the distribution manifold 150 and can pass at least a portion of the liquid phase of the first fluid to the first fluid outlet 125. The first channel 131 and the second channel 132, in some embodiments, can be separated by the distribution manifold 150, wherein the first channel 131, the second channel 132, and the distribution manifold 150 can be in fluid communication. In some embodiments, the distribution manifold 150 can be part of a plurality of distribution manifolds 150. Accordingly, in some embodiments, the one or more first channels 131 and the one or more second channels 132 can be separated by the plurality of distribution manifolds 150. The bypass channel 160, in some embodiments, can be part of a plurality of bypass channels 160, wherein the plurality of bypass channels 160 can be configured to receive at least a portion of the liquid phase of the first fluid from the plurality of distribution manifolds 150 and can pass the at least portion of the liquid phase of the first fluid to the first fluid outlet 125. The plurality of distribution manifolds 150 between the first channel 131 and the second channel 132 can collect the first fluid as it exits a first channel and can redistribute the first fluid to a second channel. The distribution manifolds can also collect a fraction of the liquid or vapor present in the first fluid and can direct it separately to one end of the heat exchanger through dedicated liquid or vapor management or bypass channels.

In some embodiments, the first fluid can be a two-phase fluid, wherein a two-phase fluid can be characterized by comprising a liquid portion and a vapor portion. The first fluid inlet 124, in some embodiments, can be in fluid communication with a first fluid source (not shown), wherein the first fluid source can comprise the first fluid substantially in a vapor phase. The first fluid can be substantially in a vapor phase, in some embodiments, when the first fluid is comprised of more than fifty percent vapor molecules. The first fluid outlet 125, in some embodiments, can be in fluid communication with one or more second channels 132 and the plurality of bypass channels 160, wherein the first fluid outlet 125 can expel the first fluid substantially in a liquid phase. The first fluid can be substantially in a liquid phase, in some embodiments, when the first fluid is comprised of more than fifty percent liquid molecules. In some embodiments, the second fluid can be a coolant. The coolant can be any coolant known in the art. The second fluid can flow through the chamber 110, in some embodiments, external to the plurality of channels 123, which can result in a transfer of heat between the first fluid and the second fluid.

An exemplary embodiment of a progression of physical properties is illustrated in FIG. 2. As shown in FIG. 2, the progression of physical properties, in some embodiments, can be based at least in part on a progression of the channel system 120 from the first end 121 to the second end 122. In some embodiments, the progression of physical properties can be based at least in part on a phase of the first fluid, wherein the first fluid can be substantially in a vapor phase at the first end 121 and can be substantially in a liquid phase at the second end 122. At least a portion of the first fluid, in some embodiments, can undergo a phase change from vapor to liquid from the first end 121 to the second end 122. Similarly, in some embodiments, a least a portion of the first fluid can undergo a phase change from liquid to vapor from the first end 121 to the second end 122. For example, in some embodiments, the heat exchange between the first fluid and the second fluid can cause at least a portion of the first fluid to condense from a vapor to a liquid, wherein at least part of the liquid portion of the first fluid can be redirected, via a distribution manifold 150, to a bypass channel 160. As shown on the left side of FIG. 2, the number of channels, in some embodiments, can change from the first end 121 to the second end 122. For example, in some embodiments, the number of channels at the first end 121 can be less than the number of channels at the second end 122. The internal channel diameter, in some embodiments, can change from the first end 121 to the second end 122. For example, in some embodiments, the internal channel diameter at the first end 121 can be greater than the internal channel diameter at the second end 122. The channel wall thickness, in some embodiments, can change from the first end 121 to the second end 122. For example, in some embodiments, the channel wall thickness at the first end 121 can be less than the channel wall thickness at the second end 122. The channel cross-sectional shape, in some embodiments, can change from the first end 121 to the second end 122. In some embodiments, the channel cross-sectional shape can be characterized by a cross-sectional area to internal channel diameter ratio. The cross-sectional area to internal channel diameter ratio can be defined as the cross-sectional area divided by the internal channel diameter for a given cross-sectional shape. For example, the channel cross-sectional shape at the first end 121 can have a first cross-sectional area to internal channel diameter ratio, and the channel-cross sectional shape at the second end 122 can have a second cross-sectional area to internal channel diameter ratio, wherein the first cross-sectional area to internal channel diameter ratio can be greater than the second cross-sectional area to internal channel diameter ratio. The number of bypass channels, in some embodiments, can change from the first end 121 to the second end 122. For example, in some embodiments, the number of bypass channels can increase from the first end 121 to the second end 122.

As shown in the right side of FIG. 2, in some embodiments, the channels 123 can have one or more fins or ribs 165 (also referred to herein as surface features or protrusions) extending inward from the outer wall of the channel into an inner volume of the channel. The size, shape, and number of fins, ribs, or other surface features can vary from the first end 121 of the channel system 120 to the second end 122 of the channel system 120. As shown in FIG. 2, as the diameter of the channel decreases, the total percentage of the internal volume of the channel occupied by the surface features can increase or decrease based on the function of the embodiment under consideration. The fins 165 can be beneficial by increasing a surface area of the internal wall of the channel.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A heat exchanger, comprising:
a chamber;
a channel system located within the chamber, the channel system comprising a first end, a second end, and a plurality of channels between the first end and the second end, wherein a physical property of the plurality of channels varies from the first end to the second end,
wherein the heat exchanger is configured to allow a first fluid to flow through the plurality of channels from the first end to the second end and a second fluid to flow through the chamber external to the plurality of channels, resulting in a transfer of heat between the first and second fluids.

2. The heat exchanger of claim 1, wherein the physical property of the plurality of channels comprises a quantity of channels.

3. The heat exchanger of claim 1, wherein the physical property of the plurality of channels comprises an internal channel diameter of the plurality of channels.

4. The heat exchanger of claim 1, wherein the physical property of the plurality of channels comprises an internal geometry of the plurality of channels.

5. The heat exchanger of claim 1, wherein the plurality of channels comprises a first channel section comprising one or more first channels having a first set of physical properties, one or more second channels having a second set of physical properties, and a distribution manifold positioned between the one or more first channels and one or more second channels, the one or more first channels, one or more second channels, and the distribution manifold being in fluid communication with each other.

6. The heat exchanger of claim 5, wherein a quantity of the one or more first channels is less or more than a quantity of the one or more second channels.

7. The heat exchanger of claim 5, wherein an internal channel diameter of the one or more first channels is greater or smaller than an internal channel diameter of the one or more second channels.

8. The heat exchanger of claim 5, wherein the heat exchanger is configured to provide a near-constant or optimally varying mass flux of the first fluid through the one or more first channels and one or more second channels, with portions of the liquid or vapor phase of the total flow being bypassed in dedicated liquid or vapor management/bypass channels.

9. The heat exchanger of claim 1, wherein the first fluid is a two-phase fluid.

10. The heat exchanger of claim 1, wherein at least a portion of the heat exchanger is manufactured by an additive manufacturing process.

11. A heat exchanger system, comprising:
a chamber defining an interior volume, the interior volume configured to receive a second fluid at a second fluid inlet and expel the second fluid at a second fluid outlet; and
a plurality of channels extending through at least a portion of the interior volume of the chamber, wherein the plurality of channels is configured to receive a first fluid at a first fluid inlet and expel a first fluid at a first fluid outlet, the plurality of channels comprising a first channel having a first physical property and a second channel having a second physical property different than the first physical property.

12. The heat exchanger system of claim 1, wherein the first and second channels are in fluid communication.

13. The heat exchanger system of claim 1, wherein the first channel is part of one or more first channels, each of the one or more first channels having the first physical property, and wherein the second channel is part of one or more second channels, each of the one or more second channels having the second physical property.

14. The heat exchanger system of claim 13, wherein a number of first channels in the one or more first channels is different than a number of second channels in the one or more second channels.

15. The heat exchanger of claim 13, wherein the first physical property is selected from group consisting of: channel length, internal channel diameter, channel wall thickness, channel cross-sectional shape, tapering profile, surface features, and wherein the second physical property is selected from group consisting of: channel length, internal channel diameter, channel wall thickness, channel cross-sectional shape, tapering profile, surface features.

16. The heat exchanger system of claim 13, further comprising a distribution manifold configured to receive the first fluid from the first channel, the first fluid comprising a liquid phase and a vapor phase, the distribution manifold further configured to pass at least a portion of the vapor phase of the first fluid to the second channel.

17. The heat exchanger system of claim 16, further comprising a bypass channel, wherein the bypass channel configured to receive at least a portion of the liquid phase of the first fluid from the distribution manifold and pass the at least a portion of the liquid phase of the first fluid to the first fluid outlet.

18. The heat exchanger of claim 1, wherein the first fluid inlet is in fluid communication with a first fluid source, the first fluid source comprising the first fluid substantially in a vapor phase.

19. A method of making a heat exchanger, the method comprising manufacturing the heat exchanger system of claim 11, wherein at least a portion of the heat exchanger system of claim 11 is manufactured via an additive manufacturing process.
